(19) United States
(12) Patent Application Publication
(10) Pub. No.: US 2005/0117973 A1
(43) Pub. Date: Jun. 2, 2005

(54) Method and system for preparing a trench and laying pipe in a trench

(76) Inventor: Jimmie P. Nelson, El Cajon, CA (US)

Correspondence Address: NATH & ASSOCIATES, PLLC, Sixth Floor, 1030 15th Street, N.W., Washington, DC, 20005, US

(21) Appl. No.: 10/946,317

(22) Filed: Sep. 22, 2004

Related U.S. Application Data
(60) Provisional application No. 60/505,322, filed on Sep. 23, 2003.

(51) Int. Cl. F16L 1/12; F16L 3/00

(52) U.S. Cl. 405/184.5; 405/170

(57) ABSTRACT

A system for laying a pipe in a trench includes subsystems and performs a method. Grading is done on pipe bed material in a trench by a remotely controlled earth mover included in a first subsystem. Pipe sections are joined to a pipe by remote control by an operator or operators outside of the trench using the second subsystem. A pipe section is lifted by a first gripper on a transport assembly and lowered into the trench in alignment with the pipe. A second gripper on the transport assembly grasps an end of the pipe, and the first gripper moves axially to insert the pipe section into the pipe. The earth mover has a material-pushing blade mounted to the pivot arms in a manner to enable a single hydraulic actuator for each pivot arm to determine height and tilt of the blade.

### CROSS-REFERENCE TO RELATED APPLICATIONS

The present application claims priority to U.S. Provisional Patent Application Ser. No. 60/505,322 filed Sep. 23, 2003, the disclosure of which is incorporated herein by reference in its entirety.

### FIELD OF THE INVENTION

The present subject matter relates to pipe laying systems, and more particularly to a system for laying pipe in a trench, including excavating and backfilling the trench, and more particularly to a system truly operable by an operator outside of the trench.

### BACKGROUND OF THE INVENTION

Many prior art patents refer to laying pipe in a trench. “Pipe laying” is often used to refer to the operation of joining a new pipe section to a pipe in the ground. Laying pipe below ground level is referred to as laying pipe below grade. However, that is just one of a number of steps that must be performed to provide an underground pipe. Pipe laying in the present context also includes other steps that are necessary between the step of initial excavation of a trench before pipe is laid below grade and the step of backfilling the trench after pipe is laid.

In order to provide a pipe below grade, a number of basic procedures are commonly necessary. First a trench is cut, and a bed, generally of gravel, is prepared and graded for the pipe to be laid in. The pipe is then laid in the trench, and opposed ends of successive pipe segments are prepared for joining. Certain types of pipe require lubrication to be applied to at least one of the opposed ends for proper joining. Once the lubrication is applied to the end, the pipe is lowered into the trench and inserted into the opposed end of the end of the successive pipe section in the trench. Normally, the outside diameter of the new pipe section is received in an inner diameter of the pipe in the trench. In order to be able to receive a pipe section of the same diameter as the pipe in the trench, the pipe end receiving the pipe needs to have an increased diameter. This is accomplished by providing each pipe section with a bell shape of increased diameter at one end. If rocks or dirt are present on the inner diameter of the pipe, the new pipe section will not be properly received. Preparation includes removing interfering particles from the inner diameter of the existing pipe. A layer of gravel of at least a preselected depth is deposited over the pipe. Finally, the trench must be backfilled.

Specific requirements for providing pipes below grade are generally mandated by local construction codes. While these codes may vary, they have several basic principles in common. The general objectives to be met in laying pipe are articulated in a publication known in the industry as the “Green Book.” This is the Standard Specifications for Public Works Construction, 2000 Edition; BNi Building News; Anaheim, Calif. Well-known standards are prescribed in this publication. For example, section 306-1.2 describes installation of pipe. Section 306-1.2.1 relates to bedding; section 306-1.2.3 relates to field joining of clay pipe; and section 306-1.3.2 relates to mechanically compacted backfill. Many techniques have been brought to bear in providing graded trenches and in joining pipes within trenches. Shortcomings in the prior art in each of these areas are examined separately.

A first area of concern is safety. One form of trench is cut having vertical walls. Working in open trenches is dangerous. Trench walls present a danger of cave-in. Uncharted or otherwise unaccounted for power lines can be encountered by workers in a trench. Placing construction personnel in the trench invokes a variety of safety requirements which greatly increase complexity and expense in construction. Safety regulations include a requirement to shore trench walls. There is a great deal of literature in the art regarding constructing retaining walls to prevent their collapse around construction personnel. Shoring of trench walls is both time consuming and expensive. Even when all safety requirements are faithfully followed, danger to construction personnel still exists, and worker injuries still occur. It is desirable to keep workers out of the trenches.

Prior patents disclose methods and means for joining pipe in trenches without construction personnel being present in the trench. U.S. Pat. No. 5,795,101 is entitled Pipe Laying Robot Apparatus and Method for Installing Pipe. Joining of a pipe section to a pipe in a trench by a workman outside of the trench is illustrated. U.S. Pat. No. 3,561,615 shows a pipe manipulating structure that can move a pipe section resting on blocks into a receiving end of a pipe. In-trench operator intervention will be required to set the blocks. This prior art does not disclose how to join the pipes under a number of foreseeable conditions without in-trench intervention by an operator. These conditions are not discussed in the prior patents.

For example, one such condition is presence of debris such as dirt and rocks on the inner diameter of a receiving pipe. If dirt and rocks are between that inner diameter and the outer diameter of an inserted pipe, there may be a failure in creating a seal between the pipe section and the pipe end. The removal of dirt, gravel and rocks prior to insertion of a pipe section into the pipe has customarily been performed by workers in trenches. Also, this prior art assumes that no adjustment is necessary to the grading. However, sections of pipe that are inserted often do not have uniform diameter. As discussed above, one end of a pipe may include an increased outer diameter bell section for receiving an end of the next pipe. In order to keep the majority of the pipe, i.e. the cylindrical portion with a smaller outer diameter, at grade, it may be necessary to scoop out a recess in the gravel pipe bed to receive the bell section. Since in-trench operator intervention will be required, use of the prior art devices will not avoid the need to shore trenches.

Another area of condition to consider is for the way in which the bed is graded. Grading trenches is very important in order to provide proper drainage. While water supply pipes inherently include a source of pressure to force water through pipes, drainage pipes do not have a continuous source of pressure behind them such as, for example, gravity as provided from a water tower. If grading is not provided within close tolerances, once water stops flowing through a drainage pipe, areas of standing water will be provided. In the case of sewage drainage, standing water can produce methane gas. Methane is highly explosive, and methane in the line presents a great danger. A grading tolerance within fractions of an inch is required.

One recent advance in grading is the provision of a self-propelled vehicle in the trench which uses automated sensors to provide the proper grade. U.S. Pat. No. 6,781,683 discloses a laser guidance system that can be used to guide earth-moving equipment. U.S. Pat. No. 5,631,658 discloses a remote control bulldozer. Vehicles are guided by a global positioning system (GPS). However, this prior art does not address a solution to particular problems of working in a trench. A base unit sits at grade level outside of the trench and transmits to an antenna on the vehicle within the trench. The line of sight from the base unit to the vehicle antenna may be blocked unless the vehicle carries an antenna on a vertical extension which may project near or above grade level. However, the vertical extension may contact utility lines or other obstacles. It is highly desirable to provide an arrangement for transmitting signals to an in-trench vehicle which does not create the danger of collision of an antenna with obstacles.

A material-pushing blade is mounted to a front end of the earthmover to forward ends of first and second pivot arms. Normally, two hydraulic actuators are required for each pivot arm to determine the height and the angle of the blade. This construction is more expensive and requires a more complicated control signal scheme than a system in which a single actuator could be used for each pivot arm.

Another shortcoming of the prior art is the manner in which pipe is covered after it is laid. Specifications generally require a contractor to be able to demonstrate that the pipe has been covered to at least a preselected depth with a bed material such as gravel. It is common practice to cover the pipe with extra gravel so that the contractor can assure a contracting authority that specifications have been met. It is not unusual for contractors to use 20% more fill than theoretically required in order to meet specifications since there is not a reliable way to otherwise document compliance with specifications. A nominal price for such fill material is $12 per ton. A contractor could expend hundreds of thousands of dollars in a year for extra fill.

Prior devices have limitations in sizes of pipes they can handle and types of pipe sections. It is preferable to be able to handle a small diameter pipe, for example, four inches, as well as the traditional drainage pipe. It is also desirable to have the ability to manipulate fittings such as wyes for lateral connections. It is also desirable to provide the capability to control the apparatus without having an operator tethered to a control box.

### SUMMARY OF THE INVENTION

Briefly stated, in accordance with the present invention there are provided a system for laying a pipe in a trench and a method. The system includes a subsystem comprising a pipe laying device and a subsystem comprising a pipe bed grading device. Grading is done on pipe bed material in a trench by a remotely controlled earth-moving machine included in a first subsystem. Pipe is laid by remote control by an operator or operators outside of the trench using a second subsystem. Preparation and pipe treatment steps are also controlled from outside the trench. The pipe is covered with a cover material, e.g. gravel, which may be provided from a conveyor carried on a truck over the trench. The first subsystem is used to grade the pipe covering layer.

In the first subsystem, a remotely controlled earthmover is remotely guided, as by an infrared laser. Remote signals control positioning of a material-pushing blade. The blade is mounted to a front end of each of first and second independently pivoted arms. Each arm pivots about a point adjacent a rear end of the earthmover. The blade is linked to the earthmover and mounted to the pivot arms in a manner to enable a single hydraulic actuator for each pivot arm to determine height and tilt of the blade.

In the second subsystem, a pipe joining system, which may be remotely operated, comprises a transport assembly and a first gripper unit supported to the transport assembly. A second gripper unit is also supported to the transport assembly and is coaxially aligned with and axially movable with respect to said first gripper unit. Each gripper unit is selectively engageable or disengageable from a workpiece, e.g. a pipe section. The transport assembly is coupled by a coupling unit to a movable support unit. The coupling unit includes roll, pitch and yaw adjusters to define the spatial orientation of the transport unit. An axial translator moves the second gripper unit with respect to the first gripper unit.

In further forms, the pipe joining system comprises means for treating pipe ends.

### BRIEF DESCRIPTION OF THE DRAWINGS

The invention may be further understood by reference to the following description taken in connection with the following drawings.

FIG. 1 is a perspective view of a machine excavating a trench;

FIG. 2 is a composite elevation, partially in cross section illustrating methods and systems utilized in accordance with embodiments of the present invention;

FIG. 3 is a plan view of the site of FIG. 2 and including some of the apparatus included in FIG. 2;

FIG. 4 is a cross sectional elevation of a pipe installed in a trench;

FIG. 5 is an elevation of a pipe laying apparatus comprising a subsystem of an embodiment of the invention;

FIG. 6 is an elevation of a pipe manipulator suspended from a boom;

FIGS. 7 and 8 are opposite side elevations of the apparatus of FIG. 6;

FIGS. 9 and 10 are partial detailed front and side elevations of the apparatus of FIG. 6 further illustrating a pipe cleaning and treatment unit;

FIG. 11 illustrates an alternative embodiment of an air or liquid line in a pipe cleaning and treatment unit;

FIG. 12 is a plan view of a control unit for commanding control circuits within subsystems;

FIG. 13 is a block diagram of a control system comprising the control unit of FIG. 12 and the pipe laying apparatus of FIG. 5;

FIGS. 14, 15 and 16 are respectively an exterior side elevation, plan view and a front elevation of a remote controlled grader;

FIG. 17 is a partial detailed side elevation of the grading apparatus viewed from an interior side; and

FIG. 18 is a plan view of a grader control unit.

### DETAILED DESCRIPTION

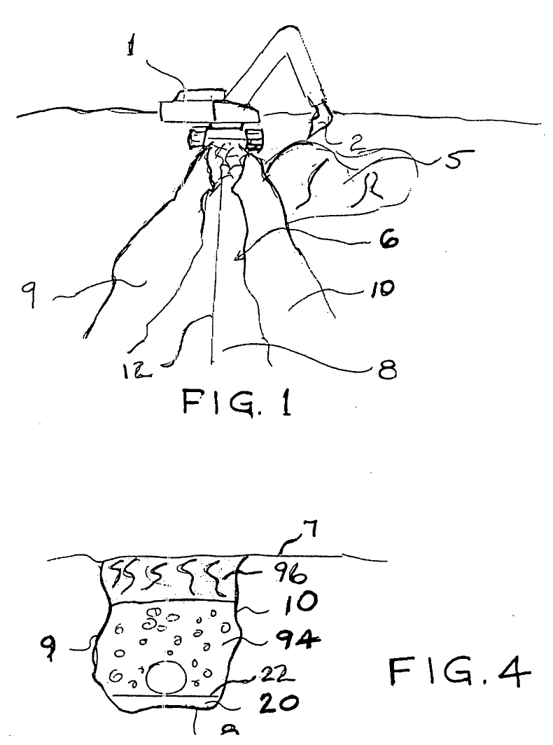

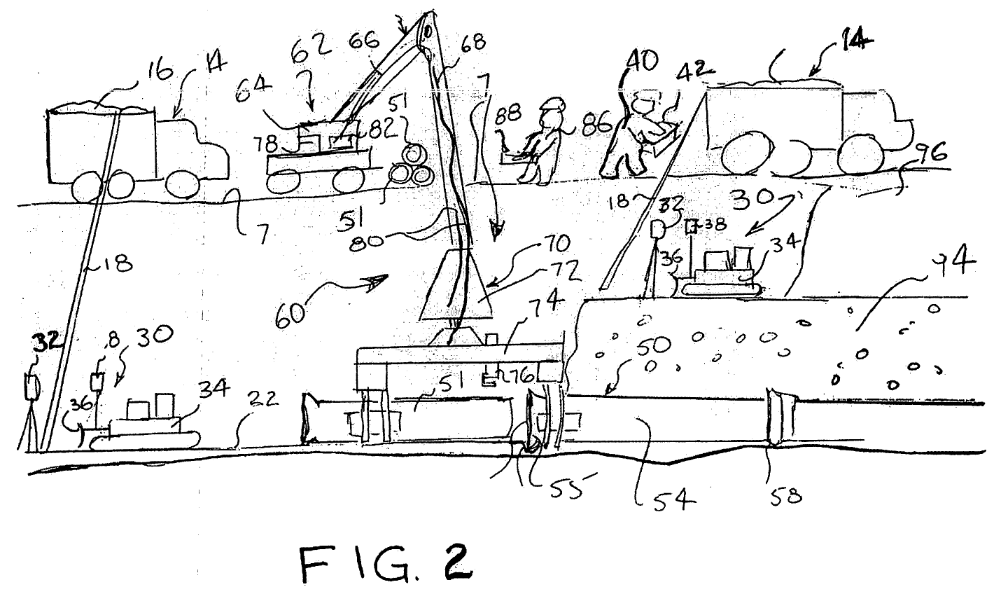

FIG. 1 is a perspective view of an excavator 1 having an excavator bucket 2 to remove earth 5 in order to dig a trench 6 below grade, i.e. surface level, 7. The trench 6 has a floor 8 and opposite side walls 9 and 10. In an application in which a 8-inch pipe will be laid, a nominal width for the trench 6 is 24 inches. The excavator 1 may straddle the trench 6 and move from time to time along a centerline 12 of the trench 6. Generally, municipal sewer specifications will dictate that the trench 6 must be substantially straight. In this case, centerline 12 is a horizontal axis. Movement parallel to the centerline 12 will be referred to as axial movement. An overview of the pipe laying procedure that follows excavation of the trench 6 is described with respect to FIG. 2. After the pipe laying procedure, the excavator 1 will move earth 5 to backfill remaining open portions of the trench 6.

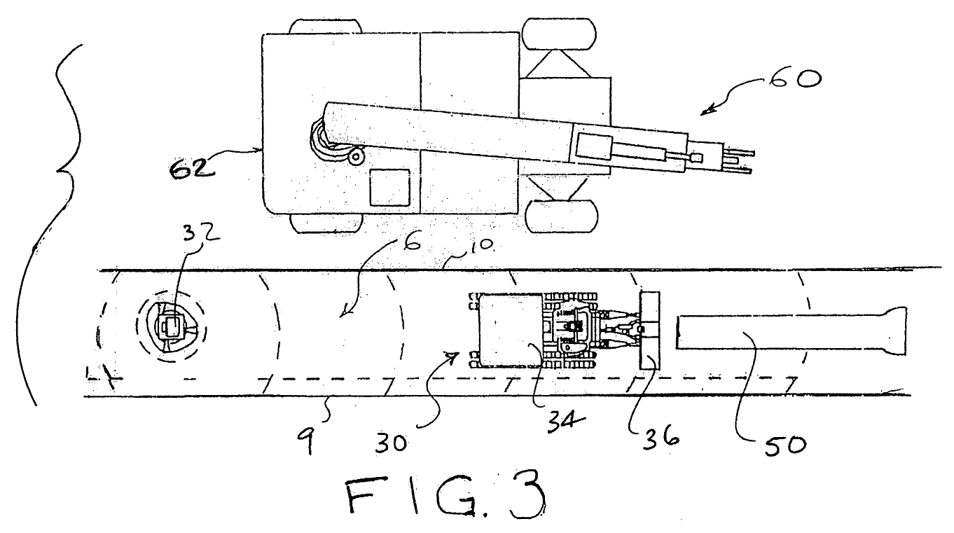

FIG. 2 is a composite illustration of a trench 6 in cross section in which apparatus used at different times in the process of laying a pipe are illustrated together. FIG. 3 is a plan view of the site of FIG. 2 with some of the apparatus of FIG. 2 shown in use. FIG. 4 is a cross sectional illustration of a pipe that has been laid below grade. The same reference numerals are used to denote corresponding components. As seen in FIG. 2, a truck 14 carries a load of bed material 16 and a conveyor 18. The bed material is selected to comply with specifications for the particular task. A common form of bed material 16 is aggregate. The conveyer 18 may dispense the bed material 16 into the trench 6 as the truck 14 travels over the trench 6. The bed material rests on the trench floor 8 to form a pipe bed 20. The pipe bed 20 has a top 22 which is initially uneven. Since a level support must be provided for pipe to be laid, the pipe bed 20 must be graded so that the top 22 is substantially planar.

In order to grade the pipe bed 20, in accordance with an embodiment of the present invention, a grading subsystem 30 is provided. The grading subsystem includes a guidance beacon 32. In a preferred form, the guidance beacon 32 is an infrared laser providing a guidance beam. The guidance beacon 32 is mounted within the trench 6. An earthmover 34 comprises a miniature bulldozer having a blade 36 for leveling the pipe bed 20. A laser detector 38 is supported to the earthmover 34 at a height to detect the guidance beam. An operator 40 located above grade may use a remote control unit 42 to control the earthmover 34.

After grading is completed, pipe is laid. A pipe 50 is illustrated in the trench 6 located on the bed 20. In the present description, “pipe” refers to a conduit located below grade. The pipe 50 comprises pipe sections 51 which are successively installed to a current end 52 of the pipe 50. Once the pipe section 51 is installed, it becomes part of the pipe 50, and its free end becomes the current end 52 of the pipe 50. In one preferred form, each pipe section 51 comprises a cylindrical body 54 at a first end and a bell 55 at a second, opposite end. The cylindrical body 54 comprises the conduit defined by the pipe 50. The bell 55 has an inner diameter approximating the outer diameter of the cylindrical body 54. The current end 52 of the pipe 50 comprises a bell 55. In assembling the pipe 50, the second end of successive pipe section 51 are inserted in the bell 55 at the current end 52. A recess 58 may be formed in the bed 20 to accommodate the greater diameter of each bell 55.

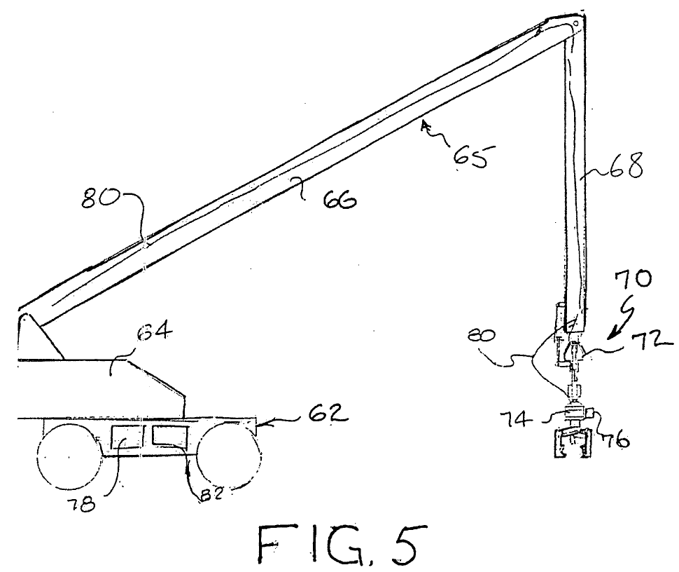

A second, pipe laying subsystem 60 is provided for handling and installing pipe sections 51. The pipe laying subsystem 60 is also illustrated in and described with respect to FIG. 5, which is an elevation enlarged with respect to FIG. 2. The pipe laying subsystem 60 comprises a tractor 62 which travels to successive positions along the length of the trench 6. Preferably, the tractor 62 will be to the side of the trench 6. The tractor 62 includes a rotatable turret 64 supporting an articulated boom 65 having a tiltable section 66 supporting a suspended section 68. The suspended section 68 may be generally maintained in a vertical orientation. The suspended section 68 supports a pipe handler 70 that includes a coupling unit 72, transport assembly 74 and a pipe treatment unit 76. The treatment performed by the pipe treatment unit 76 may comprise cleaning dirt from an inner diameter of the bell 55. Pressurized fluid, for example, may be used for cleaning. A preferred fluid is air. Additionally, pressurized lubricant may be dispensed.

The tractor 62 includes a hydraulic system 78 providing motion control through a plurality of hydraulic lines 80 coupled to various components within the pipe handler 70. Input signals may be provided to the hydraulic system 78 from a control circuit 82. The control circuit 82 may be operated by an operator 86 using a control unit 88. The control unit 88 may comprise a remote control unit communicating with the control circuit 82 by radio frequency signals. Alternatively, the control unit 88 could be wired to the control circuit 82. The operator 40 and the operator 86 could be the same person. In many applications, however, they may be separate operators 40 and 86 performing their respective functions at different locations at the same time.

The operator 86 aligns the pipe handler with a pipe section 51 above grade. Then the operator 86 controls the motion of the pipe handler 70 to move the pipe section 51 into the trench 6 and in axial alignment with the pipe 50. The pipe handler 60 grips the pipe 50 as further described below to maintain the axial alignment. The pipe treatment unit 76 may be operated, and then the pipe handler 70 is operated to slide an end of the pipe section 51 into the bell 55 of the pipe 50. The current pipe section 51 becomes part of the pipe 50. The pipe handler 70 is released from the pipe 50, and a next pipe section 51 may be added to the pipe 50 in the same manner.

FIG. 4 illustrates a completed installation. After the pipe 50 is laid, it must be covered with a cover layer 94 if local codes provide that requirement. The cover layer 94 may be aggregate. The cover layer 94 may be deposited from the conveyor 18 carried by the truck 14. The particular material used for the cover layer 94 will generally be dictated by applicable regulations or specifications. However, specifications will also generally have a requirement for a minimum depth of the cover layer 94 above the top of the pipe 50. Contractors must be able to demonstrate that this specification has been met. Common practice in the art has been to use excess amounts of material to assure that this minimum is met.

In accordance with an embodiment of the present invention, the grading subsystem 30 may again be used, this time to grade the cover layer 94. The guidance beacon 32 is set to a known height. The detector 38 can detect its height relative to the guiding beacon 32 within a preselected tolerance. The level of the upper surface of the cover layer is a fixed distance from the detector 38. The depth of the cover layer 94 is determined by subtracting the height of the pipe 50 from the height of the cover layer 94. A contractor can thus document compliance with specifications for the depth of the cover layer 94. Consequently, the contractor can avoid the expense of having to use extra fill. After the cover layer 94 is formed, the excavator 1 (FIG. 1) is used to deposit a backfill layer 96 to fill the trench to grade 7. Generally, compaction apparatus (not shown) is used on the backfill layer 96 to avoid future subsidence. These operations yield a pipe 50 installed below grade 7.

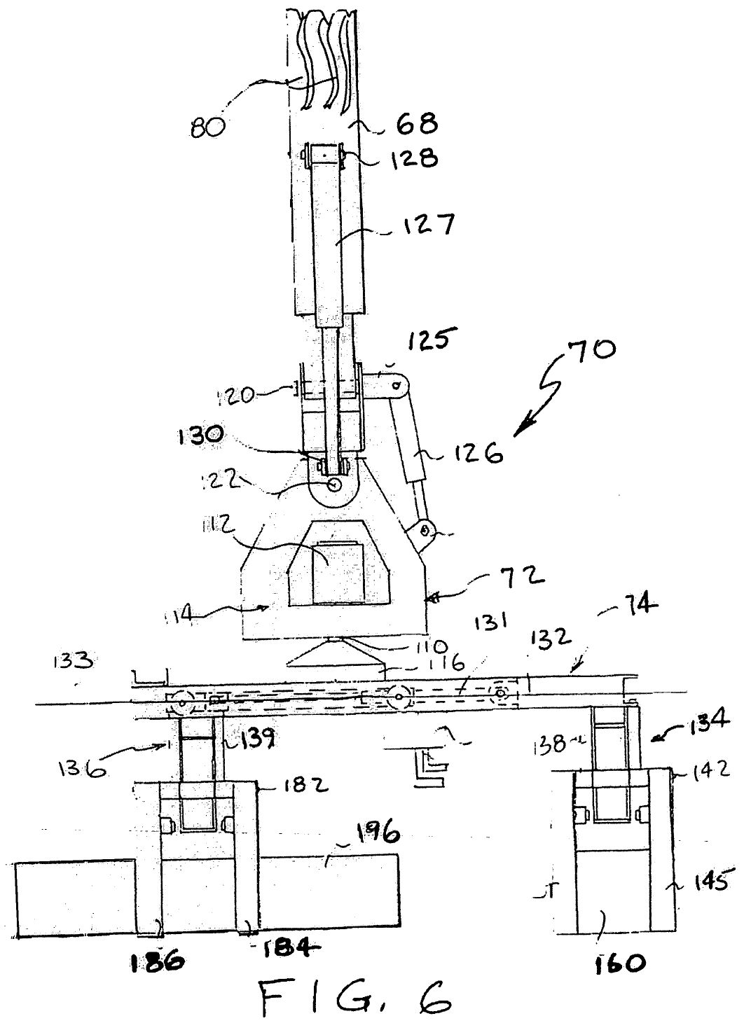

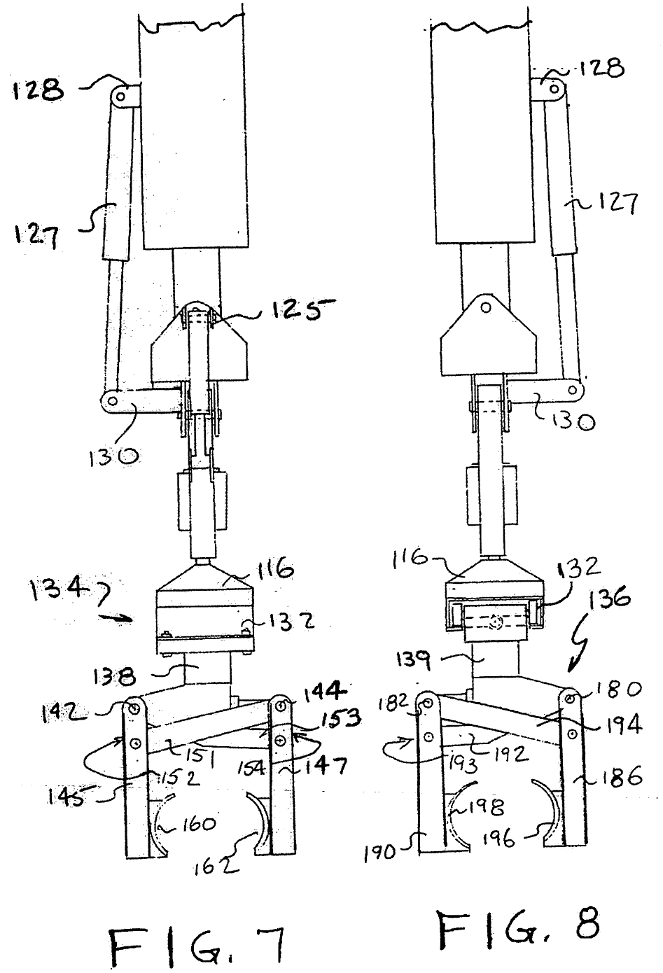

FIGS. 6-8 are partial detailed views of the pipe laying subsystem 60. FIG. 6 is an elevation of the pipe manipulator 70 suspended from the boom section 68. For simplicity in the drawing, the hydraulic lines 82 are partially broken away. FIGS. 7 and 8 are opposite side elevations of the apparatus of FIG. 6. Roll, pitch and yaw of the transport assembly 74 are determined by controlled movement of the coupling unit 72. The coupling unit 72 comprises a main plate 114. A shaft 110 is journaled in the main plate 114 and coupled for rotation by a hydraulic motor 112. The hydraulic motor 112 is supported on the main plate 114. The transport assembly 74 is coupled to the shaft 110 by a plate 116. The operator 86 (FIG. 2) controls operation of the hydraulic motor 112 to determine yaw of the transport assembly 74.

Roll and pitch of the transport assembly 74 are determined by the roll and pitch of the main plate 114. The main plate 114 is pivoted with respect to the boom section 68 in a first degree of freedom, in this case pitch, by a first pivot 120 mounted in the plate 114. The main plate 114 is pivoted in a second degree of freedom by a pivot 122 supported from the boom section 68. A hydraulic cylinder 126 is secured between a link coupling 118 on the main plate 114 and a link coupling 125 at the pivot 120. The hydraulic cylinder 126 is hydraulically connected to one of the hydraulic lines 80. When hydraulic cylinder is extended or retracted, the main plate 114 pivots about the pivot 122.

Rotation in a second degree of freedom, roll, is powered by a hydraulic cylinder 127 hydraulically coupled to one of the hydraulic lines 80. The operator 86 controls extension of the hydraulic cylinder 127 to determine pitch of the manipulator 70. A hydraulic cylinder 127 is connected at an upper end to a link coupling 128 mounted on the boom section 68. A lower end of the hydraulic cylinder 127 is connected to a link coupling 129 on an arm 130 (FIGS. 6 and 7) extending from the pivot 122. The main plate 114 rotates about the pivot 120 as the hydraulic cylinder 127 extends or retracts.

The pipe transport 74 comprises a track housing 132 supported to the plate 116. While the track housing 132 need not comprise a particular shape, it is conveniently a generally rectangular housing. Suspended from the track housing 132 are first and second clamp units 134 and 136. In one preferred form, the clamp unit 134 is fixed to the track housing 132, and the clamp unit 136 is movable with respect to the clamp unit 134. The direction of movement is preferably in a line toward or away from the clamp unit 134 along an axis 133 of the track housing 132, and is referred herein as the axial direction. Movement is provided by coupling the clamp unit 136 to a hydraulic actuator 131 which extends in the axial direction in the track housing 132. The hydraulic actuator 131 comprises an axial translator.

Referring to FIGS. 6 and 7 taken together, the clamp unit 134 is supported to the track housing 132 by a frame 138. Supported to the frame 138 are first and second pivot axes 142 and 144, preferably parallel to the axis 133. A pair of pivot arms 145 and 146 are suspended from the pivot axis 142. A pair of pivot arms 147 and 148 is suspended from the pivot axis 144. The pivot arm 148 is behind the pivot arm 146 in FIG. 6 and behind the pivot arm 147 in FIG. 7. Hydraulically actuated levers 151 and 152 operate the pivot arms 145 and 146. Hydraulically actuated levers 153 and 154 operate the pivot arms 147 and 148. A first axially extending engaging pad 160 is connected between the pivot arms 145 and 146. A second axially extending engaging pad 162 is connected between the pivot arms 147 and 148. In one embodiment of the invention, engaging pads 160 and 162 to substantially match the outer diameter of pipe section 51 (FIG. 2). When the levers 151 and 152 and the levers 153 and 154 operate, the engaging pads 160 and 162 move toward each other. In this manner, a pipe section 51 may be gripped on command.

With reference to FIGS. 6 and 8, the clamp unit 136 is supported to the track housing 132 by a frame 139. The frame 139 supports a first pivot axis 180 and a second pivot axis 182 extending in the axial direction. Axially spaced pivot arms 184 and 186 are mounted to the pivot axis 180. Axially spaced pivot arms 188 and 190 are mounted to the pivot axis 182. The pivot arm 188 is located behind the pivot arm 184 in FIG. 6 and is behind the pivot arm 190 in FIG. 8. The pivot arms 184 and 186 are operated by levers 194 and 195. The pivot arms 188 and 190 are operated by levers 192 and 193. An axially extending engaging pad 196 is supported to the pivot arms 184 and 186. An axially extending engaging pad 198 is supported to the pivot arms 188 and 190. Each of the pivot arms described above is removable from its respective pivot axis. Differently sized pivot arms may be substituted. Differently sized engaging pads may be substituted. The engaging pads may be made of rubber. However, the engaging pads need not necessarily be resilient. In this matter, different sizes of pipe may be accommodated by the pipe handler 70.

It is preferred that the engaging pads 196 and 198 are significantly elongated with respect to corresponding components in the gripper unit 134. The gripper unit 134 is used to fix the pipe handler 70 with respect to a pipe 50 in the trench 6 and needs only grip the pipe 50 adjacent the end 52. The elongated gripper unit 136 lifts a pipe section 51 from a source of supply and carries the pipe section 51 into the trench 6. In one preferred form, it is preferred to grip the pipe section along a majority of its length. The gripper unit 136 will need to support weight in addition to moving the pipe section 51 axially.

Various tools may be coupled to the track housing 132 in place of or in addition to the gripper units 134 and 136 and operated as well by the control unit 88. The tools may comprise devices for treating the pipe 50. FIG. 9 illustrates a preferred form of the pipe treatment unit 76 of FIG. 2. The pipe treatment unit 76 cleans debris from an interface at the pipe joint between the pipe 50 and pipe section 51 and can lubricate the interface as well without the need to send an operator onto the trench 6.

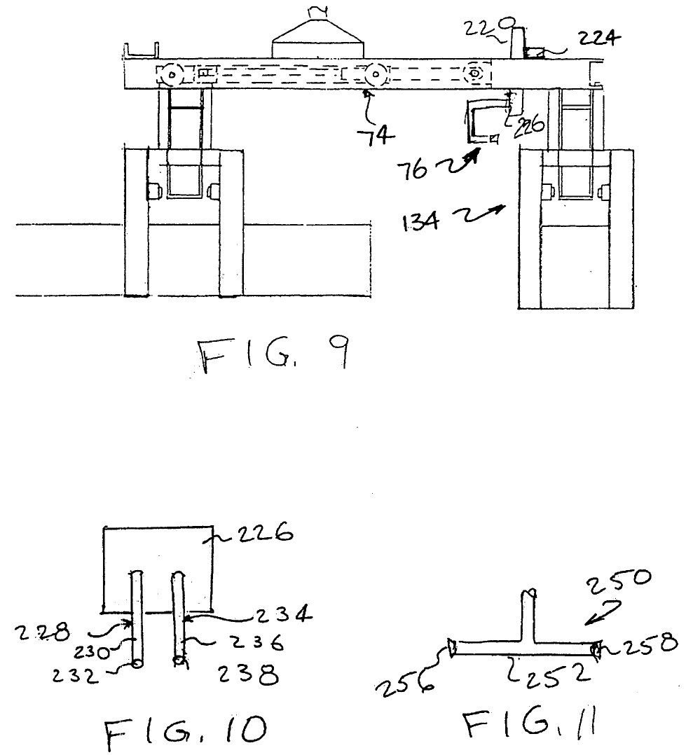

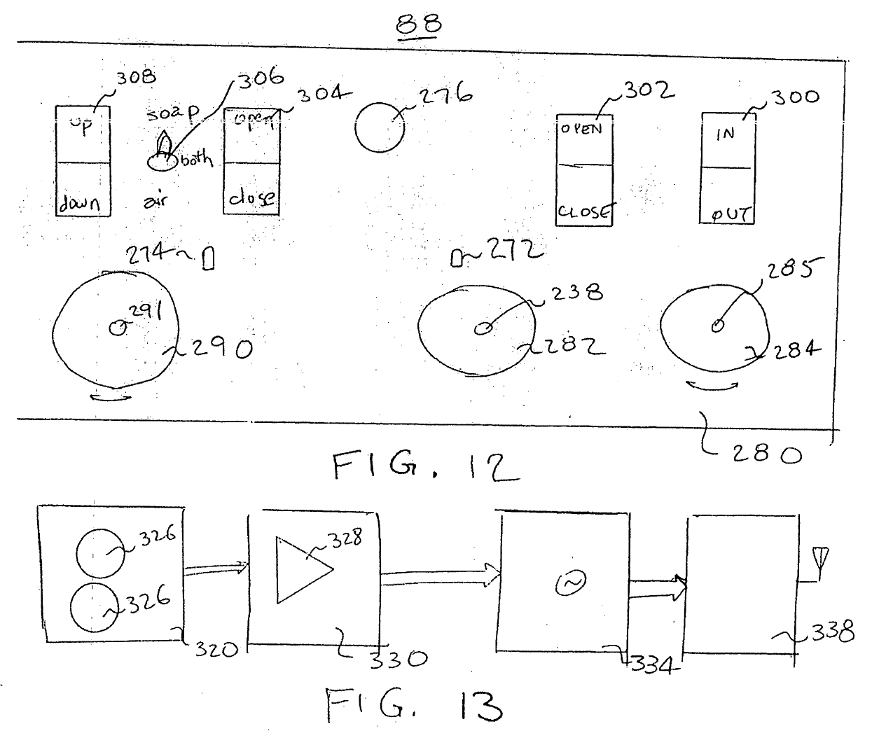

FIG. 9 is a partial detailed view of FIG. 6 illustrating the pipe treatment unit 76, FIG. 10 is a side view of FIG. 9, and FIG. 11 illustrates a further embodiment. The pipe treatment unit 76 comprises a housing 220 containing a reciprocating drive unit 224. The drive unit 224 comprises means for moving a treatment carriage 226 in treating engagement, i.e., moving treatment means into a position in which a desired treatment is performed. In the present embodiment, treatment comprises dispensing fluid. In one preferred form, treatment means are moved to a treatment position, and the treatment carriage 226 is stationary while treatment is performed. First, pressurized air is blown inside the bell 55 of pipe end 52. Additionally, a lubricating liquid may be sprayed inside the bell 55. The drive unit 224 may comprise, for example, a hydraulic motor coupled to one of the hydraulic lines 80 or a piston and cylinder unit. Alternatively, the drive unit 224 may comprise a hydraulic actuator operated by electric current. A 12-volt supply is conveniently employed in the field. The pipe treatment unit 76 is mounted for motion in a treatment path. In the present embodiment, the treatment path comprises a line segment parallel to and axially spaced from a diameter of the end 52. In the present embodiment, the motion is vertically down and then up. Motion in other directions could be provided. Depending on the structure of the treatment means, motion may be unnecessary.

In the embodiment of FIGS. 9 and 10, the treatment carriage 226 carries an air line 228 including a conduit 230 terminating in a nozzle 232. Also mounted to the treatment carriage 226 is a liquid line 234 including a conduit 236 terminating in a nozzle 238. The air line 228 is coupled to a source of compressed air that could, for example, be located on the tractor 62. A valve located at the compressed air source or at the treatment carriage 226 may be operated by the control unit 88. Similarly, the liquid line 234 is coupled to a tank which may be at the tractor 62. The tank contains lubricating liquid. One form of lubricating liquid that may be used is soapy water. The treatment carriage 226 has a normal position in which the nozzles 232 and 238 are out of the path between the pipe 50 and a current pipe section 51. After the pipe section 51 is moved into axial alignment with the pipe 50, or at a different time if desired, the drive unit 224 is activated The nozzles 232 and 238 are moved to the treatment position. In a first treatment operation, the air line 228 is actuated. Dirt and gravel are blown out of the bell 55. In a second treatment operation, the liquid line 234 is actuated, and lubricating liquid covers and inner diameter of the bell 55. In other embodiments, treatment may be performed while the treatment carriage 226 is in motion. It is also possible to provide a single pass in which an air treatment is provided when the treatment carriage 226 moves down and a liquid treatment when the treatment carriage 226 moves up.

FIG. 11 is a partial detailed view of FIG. 9 illustrating an alternative form of conduit 250 that could be included in the air line 228, liquid line 234 or both. The conduit 250 has a T-section 252 having first and second opposite ends terminating at 256 and 258 respectively. The conduit 250 may be used to treat the pipe 50 and the pipe section 51 at the same time.

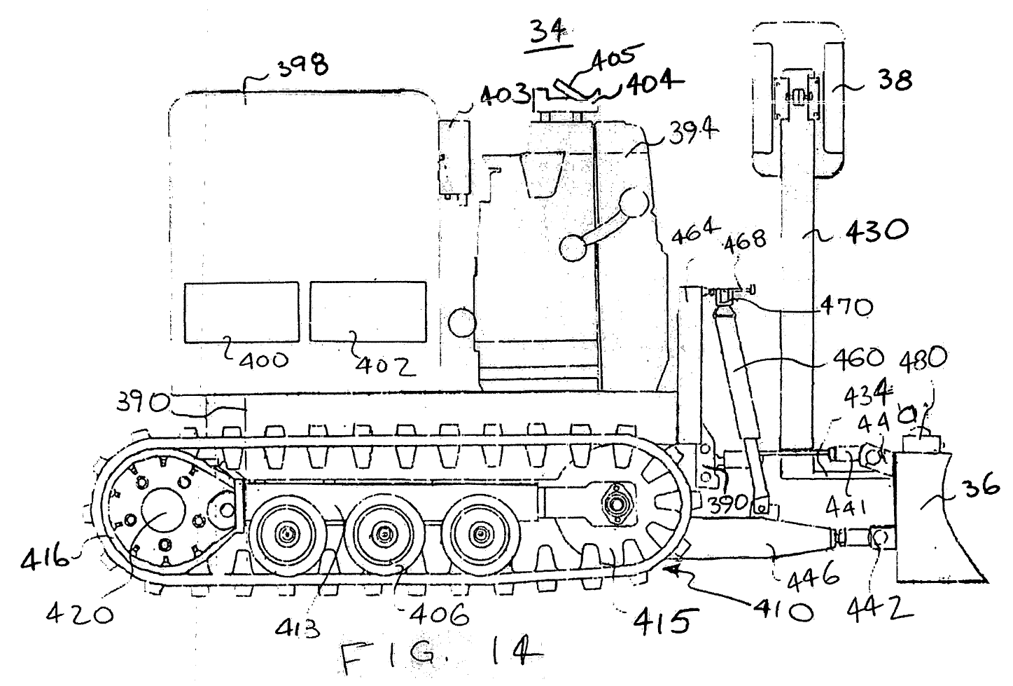

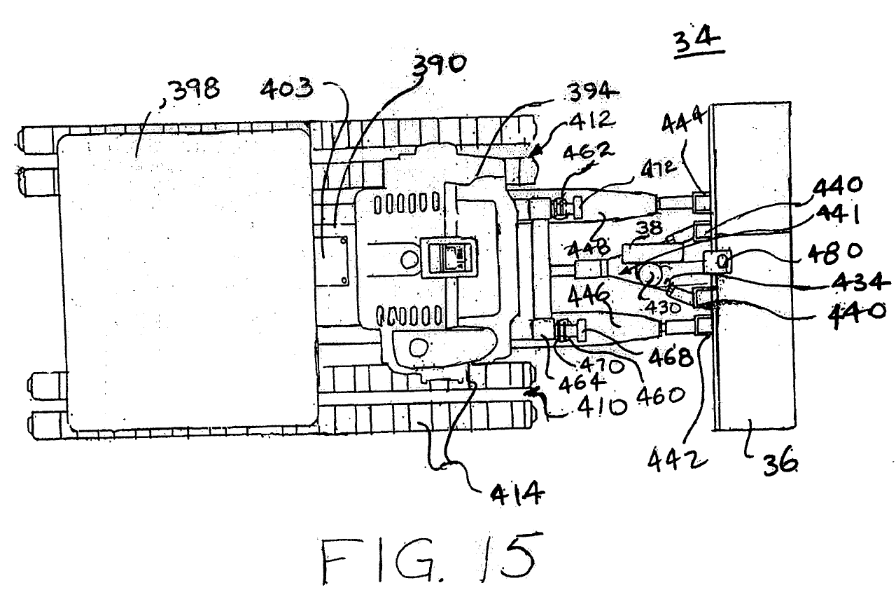

FIG. 12 is a plan view of the control unit 88. A first safety switch 272 is provided for enabling or disabling the control unit 88 in order to prevent accidental movements. A second safety switch 274 is provided to selectively enable or disable the subsystem 60. An on-off switch 276 determines the status of the link, e.g., radio transmitter, included in the control unit 88. A first control section 280 is provided to control the tractor 62. Multiposition switches 282 and 284 included in the first control section 280 may comprise joysticks controls including joysticks 283 and 285 respectively. To describe joystick positions, the 12 o'clock position is referred to as up, the 6 o'clock position is referred to as down, the 9 o'clock position is referred to as left and the 3 o'clock position is referred to as right. Movement of a joystick to a position intermediate the above-described positions combines components of the commands corresponding to the positions between which the joystick is placed. The description of the functions of the switches in the embodiment of FIG. 12 serve as direction for construction of one of several alternative forms of the control circuit of FIG. 13.

The switch 282 controls motion of the tractor 62. Motion of the joystick 283 up or down commands motion forward or backward respectively. Left or right motion steers left or right respectively. The joystick 285 is movable up and down to control raising and lowering of the tiltable section 66 of the boom 64. Left and right movement of the joystick 285 controls pivoting of the suspended section 68 with respect to the tiltable section 66. Additionally, the switch 284 may be rotated to operate the hydraulic cylinder 127 (FIG. 6) to tilt the transport assembly 74 with respect to the tractor 62.

At the left of FIG. 12, a joystick control 290 includes a joystick 291. The joystick 291 is movable up and down to operate the hydraulic cylinder 126 to control pitch of the transport assembly 74. Left and right movement of the joystick 291 controls rotation of the boom 64 with respect to the tractor 62. Rotation of the switch 290 operates the hydraulic motor 112 to rotate the pipe handler 72.

Rocker switches 300, 302, 304, 306 and 308 are provided to control handling of pipe sections 51 and treatment of the pipe joint prior to joining a pipe section 51 to the pipe 50. Each rocker switch is spring biased to a central, off position, and may be tilted about a central axis in a first or a second direction, referred to here as up and down, in order to close a first or a second pair of contacts. The rocker switch 300 is pressed up to actuate the piston drive 131 to move the clamp unit 136 toward the clamp unit 134, and is pressed down to actuate the piston drive 131 to move the clamp unit 135 away from the clamp unit 134. The rocker switch 302 is movable down or up to move the clamp unit 134 to an open or closed position. Similarly, the rocker switch 304 is movable down or up to move the clamp unit 136 to an open or closed position.

In order to provide for treatment, the rocker switch 306 is movable down or up to select treatment with air or lubricant respectively. The rocker switch 308 is movable down to move the treatment carriage 226 (FIG. 10) down and up to move the treatment carriage 226 up. Alternatively, the rocker switch 308 may be connected to initiate one cycle of down and up motion of the treatment carriage 226 by depressing the switch once in either direction.

Many other arrangements may be provided to embody the control unit 88. Use of joysticks may be desirable since many operators 86 may have developed facility with joysticks in the course of playing video games. However, many other embodiments are possible. For example, the surface of the control unit 88 could comprise a touchscreen display of a tractor 82, boom 64 and pipe handler 74. Switches in the display may be embedded at the location of illustrated components so that the operator 86 may command movement by touching images on the screen of components to be controlled. Many different assignments of function to a particular type of switch may be made.

FIG. 13 is a generalized block diagram of a control unit 88. The control unit 88 may be embodied in analog or digital circuitry. Transmission from the control unit 88 to the control circuit 82 at the tractor 62 may be via radio frequency, infrared or other links. Various forms of modulation, multiplexing and use of plural channels are known in the art to provide intelligence indicative of the various functions to be commanded. In the control circuit 88 an input stage 320 contains user-operated devices 326 which respond to the operator 86. The user-operated devices 326 may comprise the above-described switches. A voice link could also be included. Each user-operated device 326 is coupled to a sensor device 328 in a sensor stage 330. Each sensor device 328 reacts to action by the operator 86 on a user-operated device 326 by generating a voltage in an analog embodiment or a count in a digital embodiment. The sensor devices 328 provide intelligence to modulation stage 334, which imposes sensed intelligence signal on transmitted signals from a transmitter 338. In one preferred embodiment, the control unit 88 utilizes pulse width modulation.

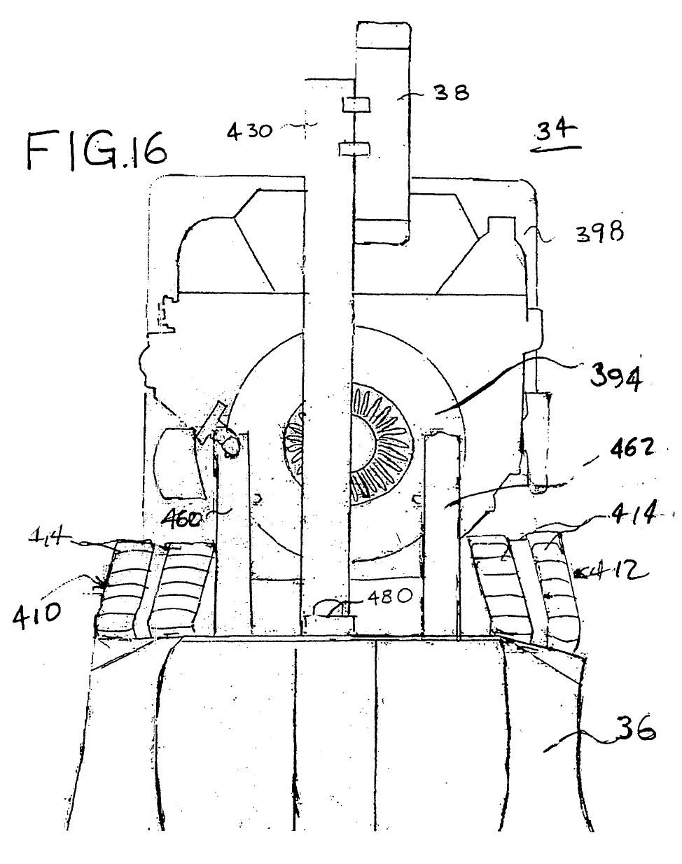

FIGS. 14, 15 and 16 are a side elevation, plan view and a front perspective view of the earthmover 34. The earthmover 34 is a miniature bulldozer in one embodiment having a chassis 390 supporting a gasoline engine 394. The chassis 390 also supports a housing 398 which may contain a control circuit 400 that receives commands from the control unit 42 (FIG. 2). The housing 398 may also contain a hydraulic system 402. The hydraulic system 402 is coupled to supply hydraulic power via a controlled manifold 403 to components further described below in order to respond to commands from the control circuit 400. For simplicity in illustration, hydraulic lines are not shown. However, the hydraulic lines are embodied in a conventional manner. The control circuit 400 may be coupled to an operator interface box 404, which may contain a receiver to respond to signals from the control unit 42. The interface box 404 may be mounted on the engine 394. A display 405 in the interface box 404 may be tilted with respect to a horizontal plane so that it is visible to an operator 40 (FIG. 2) above grade.

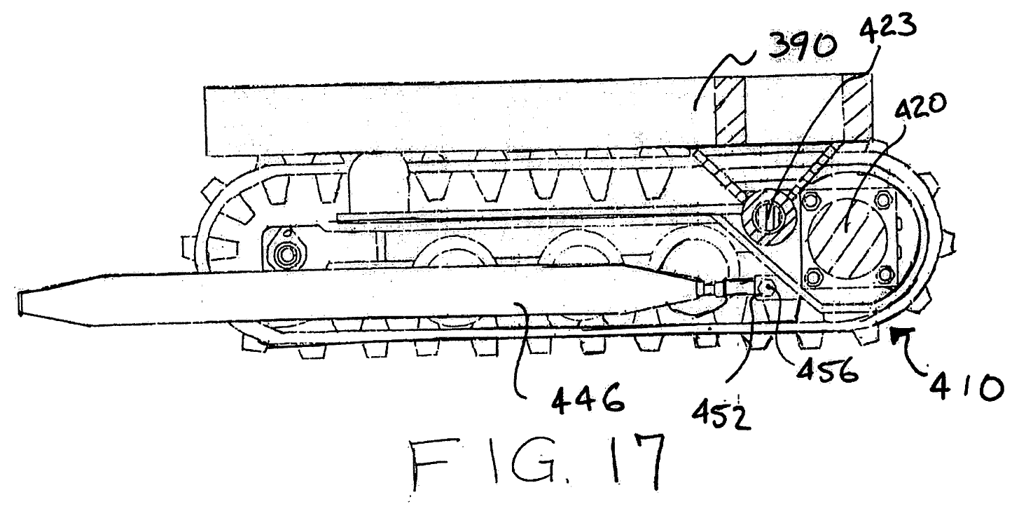

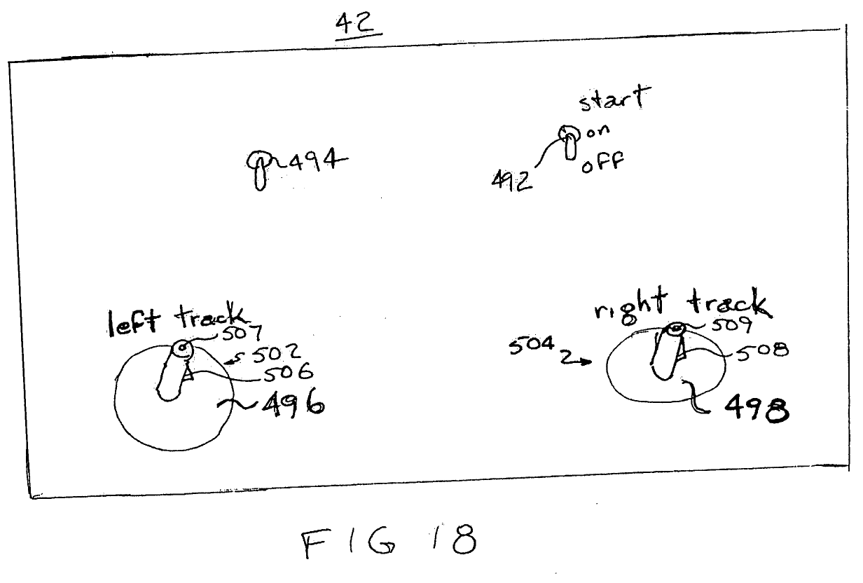

The gasoline engine 394 supplies power to a hydraulic pump to drive a hydraulic motor indicated at 420 to drive a sprocket 416 on each lateral side at the rear of the earth mover 34, e.g., the right and left sides in FIG. 16. The laterally opposed sprockets 416 are independently driven. Rollers 406 support laterally opposite track units 410 and 412. In the present embodiment, each of the track units 410 and 412 comprises a pair of tracks 414. Alternatively, single tracks 414 may be utilized. The track unit 410 loops around the sprocket 416 and an idler 415 at a rear and a forward and rear ends of a track arm 418. The track arm 418 is pivoted to the chassis 390 on a pivot axle 423. A laterally opposed, track arm 428, which is effectively a mirror image of the track arm 418 in FIG. 17 is similarly mounted to support the track unit 412. The track arms 418 and 428 can rotate independently. Consequently the earthmover 34 can stay level as inclines vary under the track units 410 and 412.

The laser detector 38 is mounted on a post 430 supported on a platform 434 projecting from the rear of the blade 36. In this manner, the inclination of the laser detector 38 with respect to the beacon 32 (FIG. 2) is indicative of the angle of the blade 36 with respect to a vertical axis. The post 430 is of a sufficient height so that the structure of the earthmover 34 will not block transmissions from the guidance beacon 32 (FIG. 2). If it is desired to avoid contact with items outside the trench 6, the post 30 should not project above grade from the trench 6.

A ball joint support 439 is supported to the chassis 390. A stabilizer rod assembly 441 has an A-shaped contour having first and second legs coupled to pivots 440a and 440b at the rear of the blade 36. The stabilizer rod assembly 441 comprises threaded rods which may be set to adjust the pitch of the blade 36. Additional pivot mounts 442 and 444 are connected to the rear side (facing the chassis 390) of the blade 36. The pivot mounts 442 and 444 are connected to forward ends of push rods 446 and 448 respectively. The push rods 446 and 448 are pivoted to the chassis 390 at pivot points 450 and 452 respectively. In accordance with an aspect of one embodiment of the present invention, this arrangement allows for push rods 446 and 448 that are proportionally longer than in prior art arrangements. The extended length provides for minimizing error in the commanded position of the blade 36. As seen in FIG. 17, the pivot point 452 is on an axis 456. Preferably, the push rods 446 and 448 are laterally inward of the track units 410 and 412 respectively.

In accordance with a further aspect of one embodiment of the present invention, the vertical position of the blade 36 is adjustable by first and second hydraulic arms 460 and 462. Lower ends of the first and second hydraulic arms 460 and 462 are pivotally secured to the push rods 446 and 448 respectively. A support for each of the upper ends of the first and second hydraulic arms 460 and 462 is provided. Posts 464 and 466 are provided, each secured to a side of a front end of the chassis 390. A retaining pin 468 passes through a mounting bracket 470 at an upper end of the hydraulic arm 460. Similarly, a retaining pin 470 passes through a mounting bracket 472 at an upper end of the hydraulic arm 462. When the first and second hydraulic arms 460 and 462 are operated, the height of the blade 36 is adjusted.

A blade slope sensor 480 is mounted to the top of the blade 36 to sense pitch, or side-to-side tilting, of the blade 36. The blade slope sensor 480 may be hard wired or coupled by a radio or optical link to the control system 400.

FIG. 18 is a plan view of the control unit 42. The conventions used to describe switch positions with respect to FIG. 12 are used here. A three position switch 492 controls gasoline engine 394. The three positions are off, on and start. A switch 494 has an on position and an off position to select the state of the laser detector 38. First and second joystick switches 496 and 498 in the current example are provided to control the track units 412 and 410 respectively. The switch 496 or 498 is moved to the up position to command forward motion, and is moved to the down position to select reverse motion. Steering is accomplished by selecting opposite directions of motion for the respective track units 410 and 412. First and second blade control switches 502 and 504 command actuation of the hydraulic arms 460 and 462 respectively. In this manner, the blade 36 is raised or lowered. In the present illustration, the switches 502 and 504 are incorporated in the joystick switches 496 and 498 respectively. The switch 502 includes a trigger switch 506 which can be grasped by a finger of and operator and a button switch 507 which can conveniently be accessed by a thumb of an operator. Similarly, the switch 504 comprises a trigger switch 508 and a button switch 509. The trigger switches 506 and 508 command motion in a first direction. The button switches 507 and 509 command motion in an opposite direction. In an alternative form, the switches 502 and 504 may comprise rocker switches with a center, neutral position and up and down positions. The up position selects raising of the respective side of the blade 36 and the down position selects lowering of the blade 36. Prior art control systems maintain travel of the earthmover 34 in a substantially straight line when no steering commands are provided. The control unit 42 may be embodied in the same manner as illustrated in FIG. 12 with respect to the control unit 88.

Embodiments of the present invention provide for reliable laying of pipe below grade while avoiding the need to expose workers to the dangers of being in a trench. One subsystem grades the trench and another subsystem connects pipe sections to the below grade pipe. The present subject matter being thus described, it will be apparent that the same may be modified or varied in many ways. Such modifications and variations are not to be regarded as a departure from the spirit and scope of the present subject matter, and all such modifications are intended to be included within the scope of the following claims.

1. A pipe joining system comprising:
a transport assembly;
a first gripper unit supported to said transport assembly;
a second gripper unit supported to said transport assembly coaxially aligned with and axially movable with respect to said first gripper unit, each said gripper unit selectively engaging or being disengaged from a workpiece;
a coupling unit coupling said transport assembly to a movable support unit, said coupling unit being settable to determine spatial orientation of said transport assembly;
said first and second gripper units being disposable to respectively engage first and second pipe sections; and
an axial translator to move said second gripper unit with respect to said first gripper unit.

2. A pipe joining system according to claim 1, wherein said coupling unit comprises mounting means for setting roll, pitch an yaw of said transport assembly.

3. A pipe joining system according to claim 2, wherein said transport assembly comprises a track having an axis and wherein said second gripper unit is supported for movement along a path parallel to said axis.

4. A pipe joining system according to claim 3, wherein said axial translator comprises a hydraulic actuator coupled between said transport assembly and said second gripper unit.

5. A pipe joining system according to claim 4, wherein each said gripper unit comprises first and second arms on opposite sides of said axis and parallel thereto, first and second suspended arms pivotally depending from each said pivot arm and axially displaced from each other, an engaging arm extending between said first and second suspended arms.

6. A pipe joining system according to claim 5, wherein said engaging pad is arcuate in a degree of freedom normal to said axis.

7. A pipe joining system according to claim 6, wherein vertical centers of said engaging pads are spaced a same distance from said respective pivot axes.

8. A pipe joining system according to claim 7, wherein said engaging pads are replaceable

9. A, pipe joining system according to claim 3, wherein said movable support comprises an articulated boom.

10. A pipe joining system according to claim 9, wherein said articulated boom is mounted on a tractor.

11. A pipe joining system according to claim 10, comprising a hydraulic circuit coupled to provide motive power to components within said system and a control system to control said hydraulic circuit, said hydraulic circuit coupled to provide motive power

12. A pipe joining system according to claim 11, further comprising a control unit for use by an operator to provide commands to said control system.

13. A pipe joining system according to claim 12, wherein said control unit comprises a remote control unit.

14. A pipe joining system according to claim 13, wherein said control system further controls motion of said tractor and said articulated boom and wherein said remote control unit comprises control signal generators for commanding motion of said tractor and said articulated boom.

15. A pipe joining system according to claim 3, wherein said transport assembly further comprises a pipe treatment unit mounted for motion in a pipe treatment path.

16. A pipe joining system according to claim 15, wherein said pipe treatment unit comprises a fluid dispenser.

17. A pipe joining system according to claim 16, wherein said fluid dispenser comprises a first conduit supplying compressed air.

18. A pipe joining system according to claim 17, wherein said fluid dispenser further comprises a second conduit supplying lubricating liquid.

19. A pipe joining system according to claim 18, further comprising a treatment carriage, and wherein said fluid dispenser is mounted on said treatment carriage, said treatment carriage being mounted for reciprocal motion in the treatment path.

20. A pipe joining system according to claim 3, further comprising an earth mover having dimensions selected for fitting in a trench.

21. A pipe joining system according to claim 20, wherein said earth mover comprises a detector to detect a line of sight guidance beacon and wherein said beacon is supported with respect to said earth mover vertically above said earth mover and at a preselected height selected to be below grade for a trench of a preselected depth.

22. A pipe joining system according to claim 21, further comprising a guidance beacon for positioning in a trench at a height to provide a line of sight to said detector.

23. A method for pipe joining below grade comprising:
providing a transport assembly comprising first and second gripper units;
gripping a pipe section with the second gripper unit;
moving said transport assembly to a position in axial registration with a pipe at a preselected axial distance therefrom;
gripping an end of the pipe with said first gripper unit;
moving the second gripper with respect to the transport assembly to insert an end of the pipe section into the pipe.

24. A method according to claim 23, further comprising releasing said first and second gripper units and moving the transport assembly away from the pipe.

25. A method according to claim 24, further comprising proving a pipe treatment unit on the transport assembly and operating the pipe treatment unit along a treatment path prior to inserting the end of the pipe section to treat the pipe.

26. A method according to claim 25, wherein operating the pipe treatment unit comprises directing compressed air at an inner diameter of the pipe.

27. A method according to claim 26, wherein operating the pipe treatment unit further comprises spraying lubricant on the inner diameter of the pipe.

28. A method according to claim 27, wherein operating the pipe treatment unit further comprises treating the end of the pipe section.

29. In a pipe joining system comprising a remote control earth mover operated below grade and comprising a blade mounted on pushrods, each said pushrod being pivoted to a chassis at a distal end of said pushrod, the improvement wherein said earth mover comprises:
a pivot mount mounting said blade on each said pushrod at a proximal end thereof;
a pivot mount pivotally mounting said blade to said chassis;
an actuator having a lower end connected to each said pushrod adjacent the proximal end, each said actuator determining placement of a respective pushrod in a vertical degree of freedom to determine height and inclination of said blade with respect to said chassis.

30. An improvement according to claim 29, further comprising first and second supports mounted on said chassis, and wherein an upper end of each said actuator is mounted to said support.

31. An improvement according to claim 29, wherein said earth mover comprises track units pivoted to said chassis about a rear bearing axis of each said track unit, and wherein each said push rod is pivoted with respect to said chassis adjacent said rear bearing axis.

32. An improvement according to claim 31, further comprising a remote control system on said earth mover to responsive to a remote control unit to operate said actuators.
